(19) United States
(12) Patent Application Publication
(10) Pub. No.: US 2021/0337993 A1
(43) Pub. Date: Nov. 4, 2021

(54) DRINKING STRAW

(71) Applicant: straw2nature Oy, Ylöjärvi (FI)

(72) Inventor: Matti KOSKINEN, Tampere (FI)

(21) Appl. No.: 17/279,801

(22) PCT Filed: Sep. 27, 2019
(86) PCT No.: PCT/FI2019/050696

§ 371 Date: Mar. 25, 2021

(30) Foreign Application Priority Data
Sep. 27, 2018 (FI) U20184172

(51) Int. Cl. A47G 21/18

(52) U.S. Cl. CPC A47G 21/18

(57) ABSTRACT

The invention relates to a drinking straw with at least one elongated suction cavity and at least one seam in the longitudinal direction. The invention also relates to a method and a system for manufacturing a drinking straw.

### SUBJECT MATTER OF THE INVENTION

The invention relates to a drinking straw. The invention also relates to a system and a method for manufacturing a drinking straw.

### BACKGROUND OF THE INVENTION

A drinking straw is typically a tubular object made of plastic and having a circular cross-section. Its one end is intended to be placed in a drink to be consumed, and its opposite end between the lips of a person to consume the drink, whereby the person can suck the drink into his/her mouth by producing an underpressure in the mouth cavity.

### BRIEF SUMMARY OF THE INVENTION

The invention relates to a drinking straw. The drinking straw is a tubular object whose elongated centre typically constitutes a suction cavity of the drinking straw. The suction cavity can be used, for example, for sucking a drink from a dish into the mouth of a person using the drinking straw.

The suction cavity of the drinking straw may have a circular cross-section, or its shape may deviate from circular.

Advantageously, a drinking straw with an elongated suction cavity has at least one longitudinal seam. Preferably, the drinking straw comprises two longitudinal seams. A drinking straw with at least one longitudinal seam, preferably two longitudinal seams, can be manufactured in a particularly cost-efficient and rapid way.

The drinking straw can be made of one or more strips. Preferably, the drinking straw comprises two strips. Preferably, said at least one strip contains at least 50 weight-% paperboard or paper; preferably, said strip or strips consists of paperboard or paper. A drinking straw containing paperboard or paper may be particularly environmentally friendly.

Preferably, the suction cavity of the drinking straw is formed between two elongated strips joined at their edges. Such a drinking straw can be made in a particularly cost-efficient way. Furthermore, such a drinking straw may be user friendly.

Advantageously, the drinking straw is provided with a trough formed by bending the strip to curve at the middle.

Advantageously, at least one strip is provided with a trough extending in the longitudinal direction of the strip, facing a similar trough of the opposite strip and forming said suction cavity with this trough.

If the drinking straw comprises two strips, the drinking straw may comprise both a strip with a trough and a strip without said trough. Preferably, the suction cavity of the drinking straw is formed by the trough(s). If the drinking straw comprises two strips, one with a trough and one without a trough, the drinking straw may maintain the desired shape of the suction cavity better.

Advantageously, at least one strip is provided with a trough in the longitudinal direction of the strip, facing the central part of the opposite strip and forming said suction cavity with the central part of this opposite strip. Said opposite strip may or may not comprise a trough. Preferably, said opposite strip does not comprise a trough. Such a shape may be not only particularly advantageous for maintaining the shape of the suction cavity but also particularly pleasant to use.

Advantageously, at least one seam of at least one strip, preferably the seams of all the strips, are joined by means of biodegradable plastic, wherein the drinking straw may be entirely compostable.

Preferably, at least one seam in the longitudinal direction of the drinking straw is heat-sealed. In other words, the drinking straw may comprise at least one heat-sealed seam in the longitudinal direction. Preferably, the drinking straw comprises two heat-sealed seams in the longitudinal direction. In addition or alternatively, the drinking straw may comprise at least one longitudinal seam which is glued. A starch-based glue may be used, for example, as the adhesive agent.

Preferably, the drinking straw is stamped out, that is, cut to a desired shape by punching. Preferably, the stamping is performed after the sealing, such as heat sealing.

Advantageously, the drinking straw has a substantially flat shape. In other words, the width of the drinking straw is preferably substantially greater than the thickness of the drinking straw.

The width of the drinking straw may be, for example, at least double the thickness of the drinking straw, preferably at least four times the thickness of the drinking straw. Preferably, the width of the drinking straw is at least five times, for example 5 to 20 times the thickness of the drinking straw. A wide straw may be easier to manufacture, whereby its manufacturing costs may be reduced. Furthermore, a wide straw may feel good in the mouth. Furthermore, a wide straw can be used not only as a straw but also as a spoon or a mixer for mixing the drink.

The drinking straw, particularly a flat drinking straw, may be conveniently used, for example, for advertising purposes, in which case suitable patterns and/or figures are cut and/or printed on the drinking straw.

According to the invention, the material is preferably compostable. The material of the drinking straw advantageously comprises paper, paperboard and/or cardboard, preferably paper and/or paperboard. Thus, the material according to the invention has the advantage of reducing the production of harmful plastic waste.

### DESCRIPTION OF THE DRAWINGS

In the following, the invention will be described in more detail with reference to the appended drawings, in which

FIGS. 1a to 1c show some examples of a drinking straw,

FIGS. 2 to 5p as well as 8a to 8b show some examples of cross-sections of a drinking straw,

FIGS. 6a to 6e show some examples of methods for manufacturing a drinking straw, and

FIG. 7 shows an extension of a drinking straw which can be connected to another drinking straw or a can.

### DETAILED DESCRIPTION OF THE INVENTION

In this application, the following reference numerals will be used:
10 drinking straw,
10a preform for a drinking straw,
1 suction cavity of a drinking straw,
2 first strip of a drinking straw,
2a first longitudinal edge of the first strip of a drinking straw,
2a second longitudinal edge of the first strip of a drinking straw,
2c longitudinal trough of the first strip of a drinking straw,
3 second strip of a drinking straw,
3a first edge of the second strip of a drinking straw,
3b second edge of the second strip of a drinking straw,
3c longitudinal trough of the second strip of a drinking straw,
11 first material roll,
12 second material roll,
13 means for sealing the drinking straw,
14 means for shaping a preform for a drinking straw before sealing,
15a, 15b cutting means for forming strips, such as one or more cutting edges,
16 cutting shaping means,
17 guiding means for pressing and shaping a strip before sealing,
18 means for conveying a strip, such as a first wheel,
19 bar, and
20 mould.

In this application, the term “elongated trough” will be used, which means a surface of the drinking straw which is capable of constituting at least part of the suction cavity of the drinking straw. Typically, the elongated trough has a curved shape and/or comprises angular shapes.

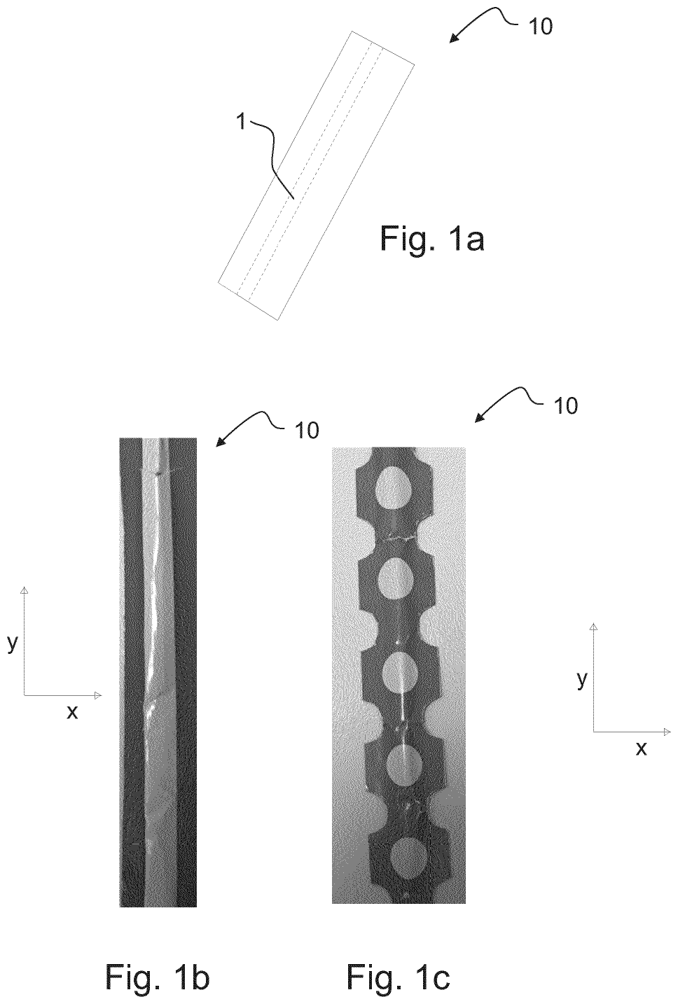

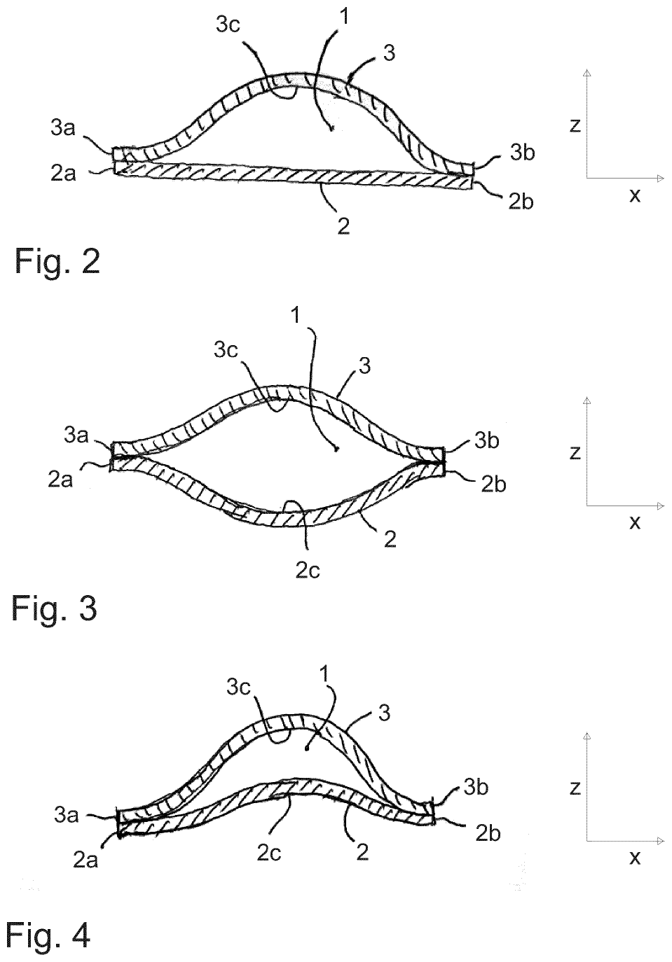

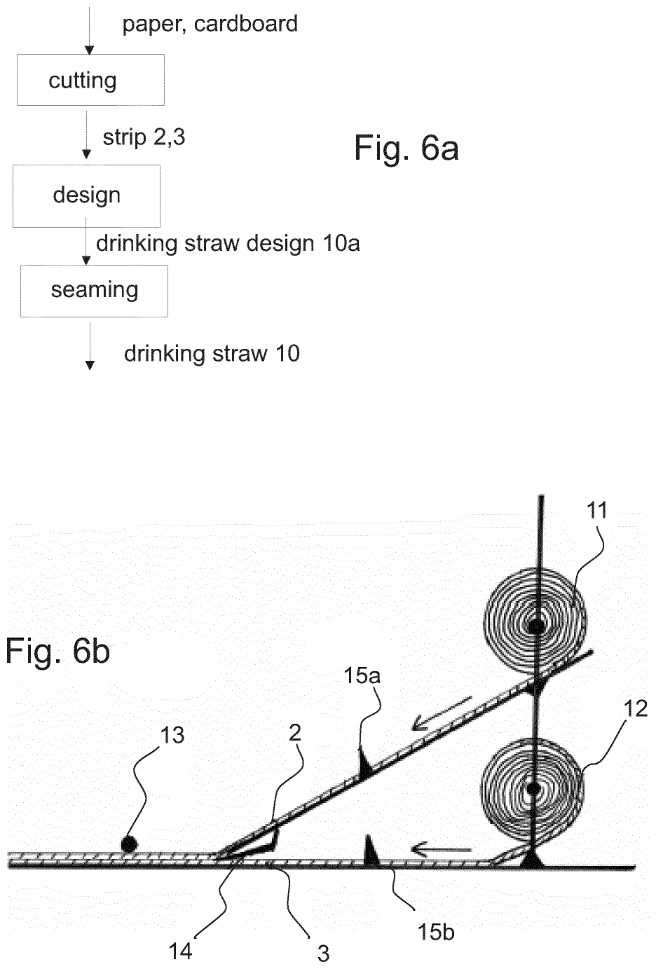

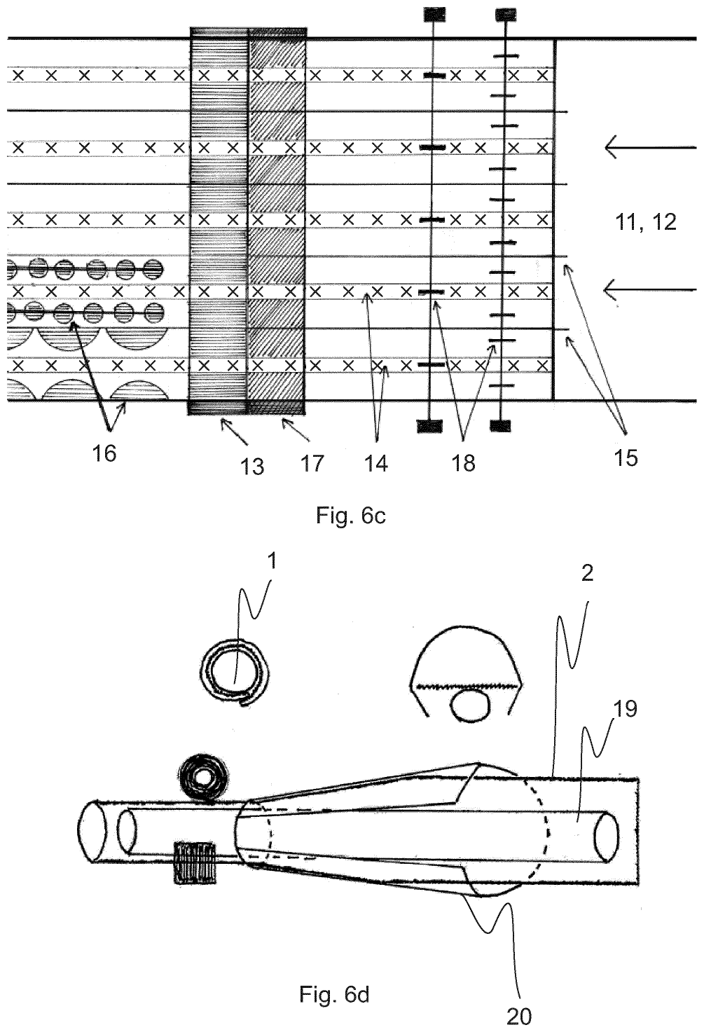

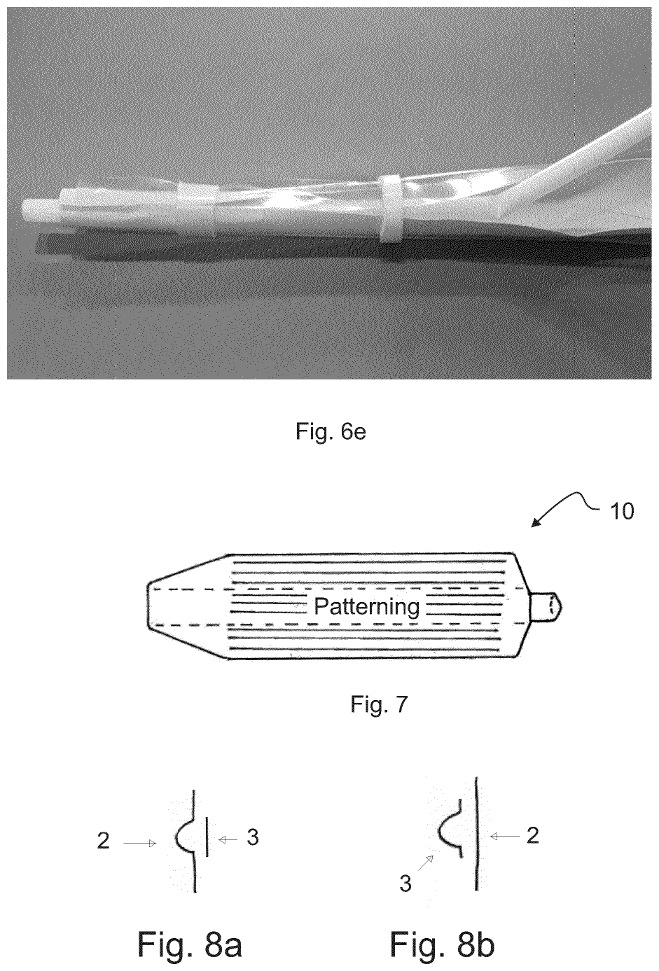

FIGS. 1a to 1c show a general view of a drinking straw 10. FIGS. 2 to 5p as well as 8a to 8b show cross-sectional views of various embodiments of a drinking straw, in which the suction cavity 1 of the drinking straw 10 is visible. FIGS. 6a to 6e show methods for manufacturing a drinking straw 10.

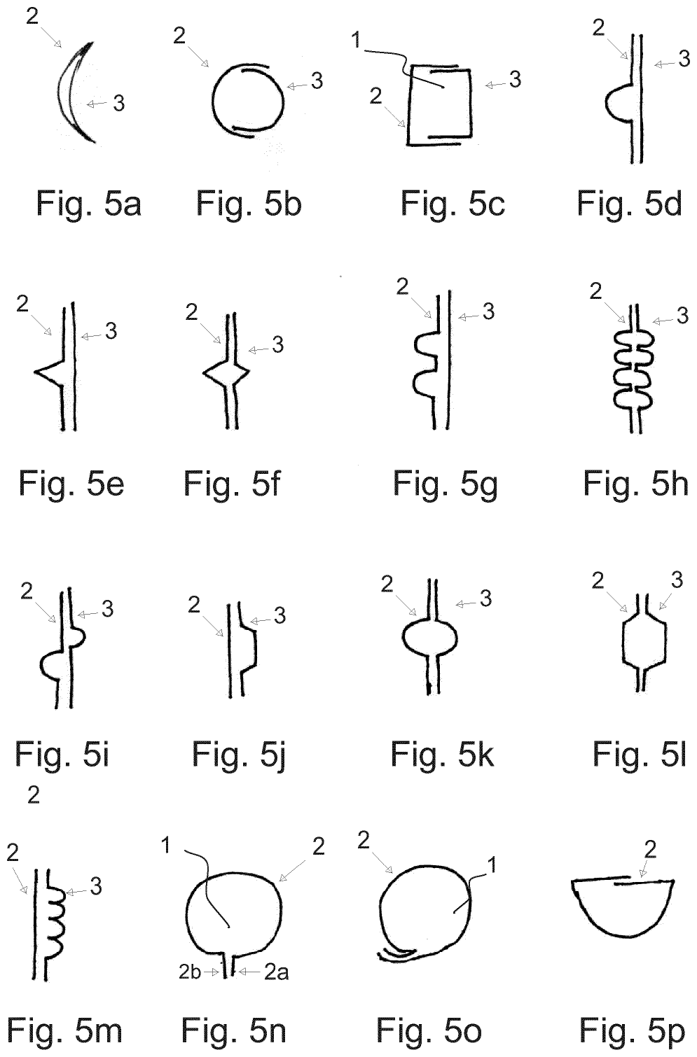

FIGS. 2 to 4, as well as FIGS. 5a to 5p and 8a to 8b show a drinking straw in a cross-sectional view perpendicular to its longitudinal direction (direction of suction). FIGS. 5b to 5m and 8a to 8b show a first strip and a second strip slightly apart, for clarity. In the finished drinking straw, the strips according to these embodiments are naturally joined together in such a way that a suction cavity can be formed between them.

The first strip 2 and/or the second strip 3 may be joined at their both edges 2a, 2b and 3a, 3b, on sufficiently wide edge areas. In this application, “edges” refer to the edges delimiting the suction cavity. It is possible that the strips 2, 3 are not joined together on their whole edge areas 2a, 2b, 3a, 3b. To achieve cost-efficient production and a good feel in the mouth, the strips are joined together preferably on their whole edge areas, from the edge delimiting the suction cavity to the outer edge of the straw.

The second strip 3 may comprise an elongated trough 3c which, together with the straight middle section of the first strips 2, forms the suction cavity 1 of the drinking straw. Such an embodiment, shown in FIG. 2, where the suction cavity is formed of two strips having different widths, is particularly advantageous in view of the manufacturing technique. Furthermore, this embodiment is particularly efficient in maintaining a suitable shape of the suction cavity 1.

FIG. 3 shows a second embodiment in which an elongated trough 2c is provided in the first strip 2 as well. Placing the inner faces of the troughs 2c, 3c of both strips 2, 3 towards each other will produce a suction cavity 1 whose cross-sectional shape is close to an ellipse or a shuttle.

FIG. 4 shows a third embodiment in which both of the joined strips are provided with a trough, but the back side of the trough 2c of the first strip 2 is placed within the trough 3c of the second strip 3. In this case, too, a suction cavity 1 is formed between the central parts of the strips, but on condition that the radius of curvature of the trough 2c of the first strip is greater than that of the trough 3c of the second strip 3. Due to different radii of curvature, this embodiment can efficiently maintain the suitable shape of the suction cavity 1.

The drinking straw may comprise two strips 2, 3 having different widths (shown, for example, in FIGS. 2, 4, 5d, 5e, 5g, 5j, 5m). Thanks to this particularly advantageous embodiment which comprises two strips 2, 3 of different widths, the drinking straw can be made in a cost-efficient way.

The suitable difference in width between the two strips will depend on the width of the product to be made. The difference in width between said strips is preferably at least 10%, for example 10 to 30%; in other words, the width of the narrower strip is preferably at least 10% smaller than the width of the wider strip. Yet another advantage may be that when two strips of different widths are joined together (as, for example, in FIGS. 2, 4, 5d, 5e, 5g, 5j, 5m), the drinking straw typically remains open better in use; in other words, the suction cavity of the drinking straw can maintain its shape well.

In addition or alternatively, the drinking straw may comprise two strips with different widths so that the first strip only covers part of the width of the second strip, as shown in FIGS. 8a and 8b. In this case, the width difference between said strips is advantageously at least 20%, more advantageously at least 30%; for example, the strip with the smaller width may be 20 to 50% narrower than the strip with the greater width. Thus, the manufacturing costs of the drinking straw may be substantially reduced.

The suction cavity 1 of the drinking straw may comprise two strips joined together, one of the strips forming a larger part and the other a smaller part of the surface area of the wall forming the suction cavity (shown in FIGS. 2, 4, 5d, 5e, 5g, 5j, 5m, 8a, 8b, for example). Thus, one of the strips 2, 3 suitably constitutes at least 60%, more suitably at least 70% of the wall area of the suction cavity. The other strip 2, 3 may suitably constitute 10 to 40%, more suitably 20 to 30% of the wall area of the suction cavity. Thanks to this particularly advantageous embodiment, the suction cavity of the drinking straw maintains the desired shape better. Furthermore, such a drinking straw can be made in a particularly cost-efficient way.

Thus, the drinking straw may comprise two strips having different widths and joined together, one forming the curved section of the suction cavity of the drinking straw, and the other forming the substantially straight section of the suction cavity of the drinking straw.

The drinking straw, and/or its cut edges, may be treated with a water-repellent coating and/or coated with a water-repellent material. In this way, the drinking straw may retain its rigidity in use longer.

If the strips 2, 3 or the sole strip consists of paper or paperboard provided with a coating to increase stability in water, the coating may be advantageously selected to act as a heat-sealing material as well.

In practice, the drinking straw 10 can be advantageously made by running the strips, such as paperboard or paper strips, shaped as described above, together so that their outer edges are jointed, leaving one or more suction cavities between these outer edges. Such a method is particularly cost-efficient, and it can be applied to make a large number of straws simultaneously. The strip may have the length of several drinking straws, and e.g. after shaping, it can be cut to drinking straws 10 of suitable length.

If the facing surfaces of the strips 2, 3 are provided with a coating of biodegradable plastic, the strips can typically be heat-sealed together at their outer edges.

The drinking straw can be made of any suitable material. The drinking straw is preferably made of a compostable material. The compostable material may be a particularly environmentally friendly material.

The drinking straw 10 can be made of e.g. a laminate or another material which is entirely or partly plastic.

Preferably, the straw comprises paper, paperboard and/or cardboard, or consists of said paper, paperboard and/or cardboard. Advantageously, the content of paper, paperboard and cardboard, preferably paperboard and/or cardboard, is at least 50% or at least 60%, more advantageously at least 70% or at least 80%, and most advantageously at least 90%, at least 95% or at least 98% of the whole straw, in dry weight. Said material may be a particularly environmentally friendly material. Furthermore, said material may be a particularly good printing substrate.

In this application, paper, paperboard and cardboard refer to a natural fibre based material which is suitably compostable as such, and recyclable.

The material used for making a drinking straw is preferably water-tight or substantially water-tight paper or thin paperboard, so that the drinking straw maintains its rigidity when liquid is sucked through it. The grammage of the material is advantageously 60 to 260 gsm. More advantageously, the grammage of the material is lower than 240 gsm, or lower than 220 gsm, preferably lower than 200 gsm. A lower grammage of the material will help to save in material costs and transportation costs. Cardboard, or thick waterproof paper, is a particularly suitable material because it can make the drinking straw suitably rigid.

The drinking straw may comprise biodegradable film.

In an embodiment, one of the halves of the drinking straw, made of the first strip 2, consists of paperboard or another rigid material, and the other half of the drinking straw consists of a considerably thin material, such as a clearly thinner laminate or, for example, biodegradable plastic. This may reduce the manufacturing costs substantially without impairing the quality of the drinking straw to a significant extent.

If the drinking straw comprises two strips, one strip consisting of a considerably more rigid material than the other strip, the more rigid strip preferably constitutes a larger part of the wall area forming the suction cavity.

The drinking straw may be formed of, for example, one strip or two strips. A suction cavity 1 is formed inside the outer edges of the drinking straw 10.

The drinking straw 10 may be formed of a single strip 2, 3. In this case, the single strip 2 is advantageously rolled to attach the first longitudinal edge of the strip to the second longitudinal edge of the strip. In other words, to form the drinking straw 10, the first longitudinal edge 2a of the strip 2 is fastened to the second longitudinal edge 2b of said strip; that is, the suction cavity 1 of the drinking straw 10 is formed within the single elongated strip 2 whose edges are joined as shown in FIG. 5n. The fastening slip formed in this way (the joined longitudinal edges of the strip) can be further attached to the circular shape, as shown in FIG. 5o. In other words, the fastening slip can be folded parallel to outer surface of the circular shape, and attached to it.

In an embodiment, shown in FIG. 5p, the strip is folded to have a semicircular shape.

Alternatively, the drinking straw 10 may be formed of two strips 2, 3. In this case, the first longitudinal edge of the first strip 2 is attached to the second longitudinal edge of the second strip 3, and the second longitudinal edge of the first strip 2 is attached to the first longitudinal edge of the second strip 3. In other words, the suction cavity 1 of the drinking straw 10 is formed between two elongated strips 2, 3 joined at their edges.

If the drinking straw 10 comprises two strips 2, 3 or consists of two strips, the material of the first strip may be clearly thinner than the material of the second strip. In this case, the grammage of the material of the first strip may be, for example, at least 20%, more advantageously at least 30% or at least 40% and most advantageously at least 50% lower than the grammage of the material of the second strip. In this way, it is possible to make a functional drinking straw 10 and simultaneously to save in the material costs. Furthermore, this alternative may be particularly environmentally friendly.

Thus, the drinking straw 10 comprises at least one strip, such as one, two, three, or four strips. Preferably, the drinking straw 10 comprises one or two strips 2, 3.

The above-mentioned drinking straw 10 made of one or two strips may be particularly cost-efficient to make. Furthermore, especially a drinking straw comprising two strips can be made in an extremely efficient way, and it may be particularly well suited for printing and/or for advertising.

The drinking straw 10 should be waterproof to be used for drinking a liquid.

A food-grade plastic film, such as a polyethylene (PE) film or a polylactide (PLA) film, may be laminated on the paper. Preferably, said food-grade plastic film consists of bio-based plastics, such as PLA, or polyethylene made via the sugar-ethanol-ethylene route. Advantageously, said food-grade plastic film is biodegradable.

Alternatively, the surface of the paper may be coated with a food-grade wax to provide sufficient water tightness. In an example, the drinking straw is provided with a coating made of sugar-cane. In this way, sufficient water tightness can be provided for the straw.

The drinking straw, such as a drinking straw containing e.g. coated paper and/or paperboard, may have a coating content of e.g. 15 to 30 weight-%.

One example of a coating for the drinking straw is so-called Colombier BioBarrier.

In an embodiment, heat-sealable paperboard which is not separately coated with plastic is used as the material.

The elongated side of a drinking straw made of at least one strip, preferably both elongated sides of a drinking straw 10 made of two strips, are closed to form a water tight suction trough 1.

One or more longitudinal side seams of the drinking straw are preferably sealed by heat-sealing. In this way, no specific glues are needed in the manufacture of the straw. Heat-sealability may be achieved by coating at least one side of the strips, in part or in whole, with a heat-sealable material, such as a heat-sealable biodegradable plastic. Preferably, at least the longitudinal edges are thus coated with a heat-sealable material. Thus, the heat-sealable material may be applied in such a way that said heat-sealable material is provided on both sides of the inner seam to be heat-sealed.

If the drinking straw is made of a single strip, the strip is preferably rolled by a mould 20 and a press to a circular and/or spiral shape, after which the longitudinal seam formed is closed (shown in FIGS. 6d to 6e). Closing the seam, i.e. sealing, is preferably carried out against a bar 19. Preferably, the sealing is done by heat-sealing. This is shown in FIG. 6d. FIG. 6d also shows a jointing tool and a roll conveying the paperboard forward and providing the jointing tool with a counterweight during the sealing.

If a bar 19 is used in the manufacture of the drinking straw, the shape of the bar is selected according to the shape of the drinking straw. The bar, which is placed within the suction cavity being formed during sealing of the drinking straw, may be circular or have a shape different from the circular shape. The bar may be, for example, circular, semi-circular, square, or polygonal.

One or more longitudinal side seams of the drinking straw may be sealed by applying a food-grade adhesive. Alternatively, one or more side seams of the drinking straw may be closed by applying a food-grade adhesive tape. Preferably, one or more longitudinal side seams of the straw are closed by heat-sealing.

The straw can be made, for example, by making several straws simultaneously over the whole width of a material roll, such as a roll of paper, paperboard or cardboard.

Advantageously, said material roll is cut into slips of desired width, i.e. strips 2, 3. The width of said slips, i.e. strips 2, 3, may be, for example, 1 to 8 cm; advantageously, the width of each strip is at least 2 cm. Furthermore, the width of each strip is advantageously not greater than 6 cm. By adjusting the width of the paperboard and by varying the number of moulds, the production can be easily adjusted to the need. Said one or more single strips made in this way are suitably guided via the mould and the press to obtain the desired shape of the drinking straw. In this way, drinking straws can be made in a particularly cost-efficient and environmentally friendly way.

By stamping, the drinking straw 10 can be provided with various profiles. Preferably, the drinking straw 10 is stamped to provide patterns on the outer surface of the straw. For example, the straw can be provided with corrugated, perforated and/or serrated patterns.

FIGS. 6a to 6e show examples of methods for manufacturing the drinking straw. Advantageously, a material 11, 12 is introduced in a cutting station to be cut into strips 2, 3 of desired size.

Advantageously, the material 11, 12 is in the form of a roll. Thus, the production of the drinking straw can be implemented in an easy and cost-efficient way. Advantageously, one or two rolls of material 11, 12 are provided.

FIG. 6b shows a first material roll 11 and a second material roll 12. The first and/or second material rolls advantageously consist/s of paper, paperboard and/or cardboard.

FIG. 6c shows an example of a method for manufacturing a drinking straw. The figure shows means 13 for sealing the drinking straw, means 14 for shaping a preform for the drinking straw before sealing, cutting means 15 for forming the strips, cutting shaping means 16 for e.g. stamping the drinking straw, a guide 17 for pressing and shaping the strip before sealing, means 18 for conveying the strip, such as a wheel.

The material 11, 12 is preferably supplied to cutting means 15a, 15b for cutting the material into strips 2, 3.

After forming strips 2, 3 of the material, the strips are shaped into desired forms. Preferably, the strips 2, 3 are introduced to the means for shaping 14 a preform for a drinking straw. The shaping can be done, for example, by bending said strip 2, 3 to the desired shape, to constitute a preform for a drinking straw, by said means 14.

After this, the preform for a drinking straw is preferably sealed to form a drinking straw 10 with at least one seam in the longitudinal direction. For this, the shaped strip 2, 3 is preferably conveyed to the means 13 for sealing the drinking straw. The sealing can be done, for example, by heat-sealing.

In the manufacture of the drinking straw 10, the single strips are preferably bent to have a curved cross-section, at least in the centre. In this way, a trough is formed in the central part of the drinking straw. The inner face of said trough can be placed against another strip, whereby the suction cavity of the drinking straw is formed between the inner face of the trough and the central section of the opposite strip. Said other strip may be straight (unbent) or bent in a corresponding way to form a trough in its central section. FIGS. 5a to 5p show some possible shapes of a trough.

Drinking straws 10 can be efficiently made by this method. Thanks to this production method, at least 100 straws can be made per minute, preferably at least 300 straws per minute, in each production line. The efficiency of the method is based, among other things, on the fact that large, wide rolls can be used. Thus, the space saving of the machine needed for the manufacture may be considerable, with respect to the production.

The method has the advantage that the manufacture is considerably more rapid compared with making e.g. a paper straw of a thin paper ribbon by twisting to form a tubular straw. Furthermore, a straw made of a thin paper ribbon may have poorer water resistance than a straw made of a thicker paper material, paperboard or laminated paper material.

Advantageously, the straw is an advertising substrate; that is, desired patterns and/or advertisements and/or other information may be printed on it. Preferably, the drinking straw 10 has patterns printed on it.

The profile of the drinking straw 10 may vary, for example due to said pressing and stamping. FIGS. 2 to 5p show various possible cross-sections of the drinking straw. As shown in the figures, very different shapes are possible.

The drinking straw 10 can be made in a substantially flat shape. Thus, the first dimension of the cross-section of the drinking straw 10 may be substantially smaller than the second dimension of the cross-section of the drinking straw. This substantially flat shape of the drinking straw 10 brings the advantage, for example, that it may also be used for mixing a drink.

The drinking straw 10 can also be manufactured in a shape with a square cross-section. In such a case, the drinking straw with a square cross-section can be flattened out, for example for storage and/or transportation, or for mixing a drink with said square straw. The square straw can not only be flattened out but also re-opened by squeezing at the edges.

The drinking straw 10 can also be manufactured in a shape with a circular cross-section. Thus, the drinking straw made in a shape with a circular cross-section can preferably be flattened out, for example, for storage and/or transportation of the drinking straw, or for mixing a drink with the straw having said circular cross-section. Such a straw can be opened, for example, by squeezing at the edges. Some users may find curved shapes more pleasant than sharper shapes of the drinking straw.

1. A drinking straw comprising an elongated suction cavity, wherein said drinking straw has at least one seam in the longitudinal direction.

2. The drinking straw according to claim 1, wherein said strips contain at least 50 weight-% paperboard or paper; preferably, said strips consist of paperboard or paper.

3. The drinking straw according to claim 1, wherein the strips are joined by biodegradable plastic.

4. The drinking straw according to claim 1, wherein said at least one longitudinal seam is heat-sealed.

5. The drinking straw according to claim 1, wherein the drinking straw has a substantially flat shape.

6. The drinking straw according to claim 1, wherein the drinking straw comprises two seams in the longitudinal direction.

7. The drinking straw according to claim 1, wherein the drinking straw comprises two strips, i.e. a first strip and a second strip.

8. The drinking straw according to claim 7, wherein the first strip and the second strip have different widths so that the width of the narrower strip is advantageously at least 10% smaller than the width of the wider strip.

9. The drinking straw according to claim 7, wherein the suction cavity is formed between two elongated strips joined at their edges.

10. The drinking straw according to claim 7, wherein at least one of the strips comprises a trough extending in the longitudinal direction of the strip and facing the central section of the opposite strip, forming said suction cavity with this central section.

11. The drinking straw according to claim 10, wherein said opposite strip also comprises a trough in the longitudinal direction of the strip.

12. The drinking straw according to claim 10, wherein said opposite strip does not comprise a trough in the longitudinal direction of the strip.

13. The drinking straw according to claim 10, wherein the trough has been formed by bending the strip to curve in its central section.

14. A method for manufacturing a drinking straw, the method comprising:
supplying a material,
cutting the material to form at least one strip,
shaping said at least one strip, and
sealing at least one edge of said at least one shaped strip, to form a drinking straw.

15. The method according to claim 14, wherein exactly one strip is sealed to form a drinking straw.

16. The method according to claim 14, wherein two strips are sealed to form the drinking straw.

17. The method according to claim 16 for forming a drinking straw, the method comprising
cutting a material to form at least two strips so that said at least two strips have different widths, and
sealing said strips of different widths together to form the drinking straw.

18. The method according to claim 14 for manufacturing a drinking straw, wherein the sealing is performed against a bar which is placed inside a suction cavity being formed during the sealing.

19. A system for manufacturing a drinking straw, the system comprising:
cutting means for forming at least one strip of material,
shaping means for shaping said one or more strips formed, and
sealing means for sealing said at least one shaped strip, to form a drinking straw.

20. The system according to claim 19, wherein the sealing means comprise a bar.
